(19) United States
(12) Patent Application Publication
(10) Pub. No.: US 2023/0291515 A1
(43) Pub. Date: Sep. 14, 2023

(54) PHYSICAL UPLINK SHARED CHANNEL REPETITIONS WITH TRANSPORT BLOCK SCALING AND FREQUENCY HOPPING

(71) Applicant: QUALCOMM Incorporated, San Diego, CA (US)

(72) Inventors: Jing DAI, Beijing (CN); Chenxi HAO, Beijing (CN); Chao WEI, Beijing (CN); Gokul SRIDHARAN, Sunnyvale, CA (US); Hung Dinh LY, San Diego, CA (US)

(21) Appl. No.: 18/007,029

(22) PCT Filed: Sep. 29, 2020
(86) PCT No.: PCT/CN2020/118731

§ 371 Date: Jan. 26, 2023

(51) Int. Cl. H04L 5/00

(52) U.S. Cl. CPC H04L 5/0044; H04L 5/0012

(57) ABSTRACT

Various aspects of the present disclosure generally relate to wireless communication. In some aspects, a user equipment (UE) may determine a transport block size based at least in part on a set of physical uplink shared channel resources corresponding to a set of physical uplink shared channel repetitions that are configured to be transmitted over a repetition unit having a plurality of slots in accordance with a frequency hopping pattern that is configured such that a repetition slot count associated with the repetition unit and a frequency hop length are related by an integer-multiple relationship. The UE may transmit the set of physical uplink shared channel repetitions based at least in part on the transport block size. Numerous other aspects are provided.

### FIELD OF THE DISCLOSURE

Aspects of the present disclosure generally relate to wireless communication and to techniques and apparatuses for physical uplink shared channel repetitions with transport block scaling and frequency hopping.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes determining a transport block size based at least in part on a set of physical uplink shared channel (PUSCH) resources corresponding to a set of PUSCH repetitions that are configured to be transmitted over a repetition unit having a plurality of slots in accordance with a frequency hopping pattern that is configured such that a repetition slot count associated with the repetition unit and a frequency hop length are related by an integer-multiple relationship; and transmitting the set of PUSCH repetitions based at least in part on the transport block size.

In some aspects, a method of wireless communication performed by a base station includes transmitting a PUSCH repetition configuration comprising an indication to determine a transport block size based at least in part on a set of PUSCH resources corresponding to a set of PUSCH repetitions that are configured to be transmitted over a repetition unit having a plurality of slots in accordance with a frequency hopping pattern that is configured such that a repetition slot count associated with the repetition unit and a frequency hop length are related by an integer-multiple relationship; and receiving the set of physical uplink shared channel repetitions based at least in part on the transport block size.

In some aspects, a UE for wireless communication includes a memory and one or more processors coupled to the memory, the memory and the one or more processors configured to: determine a transport block size based at least in part on a set of PUSCH resources corresponding to a set of PUSCH repetitions that are configured to be transmitted over a repetition unit having a plurality of slots in accordance with a frequency hopping pattern that is configured such that a repetition slot count associated with the repetition unit and a frequency hop length are related by an integer-multiple relationship; and transmit the set of PUSCH repetitions based at least in part on the transport block size.

In some aspects, a base station for wireless communication includes a memory and one or more processors coupled to the memory, the memory and the one or more processors configured to: transmit a PUSCH repetition configuration comprising an indication to determine a transport block size based at least in part on a set of PUSCH resources corresponding to a set of PUSCH repetitions that are configured to be transmitted over a repetition unit having a plurality of slots in accordance with a frequency hopping pattern that is configured such that a repetition slot count associated with the repetition unit and a frequency hop length are related by an integer-multiple relationship; and receive the set of PUSCH repetitions based at least in part on the transport block size.

In some aspects, a non-transitory computer-readable medium storing a set of instructions for wireless communication includes one or more instructions that, when executed by one or more processors of a UE, cause the UE to: determine a transport block size based at least in part on a set of PUSCH resources corresponding to a set of PUSCH repetitions that are configured to be transmitted over a repetition unit having a plurality of slots in accordance with a frequency hopping pattern that is configured such that a repetition slot count associated with the repetition unit and a frequency hop length are related by an integer-multiple relationship; and transmit the set of PUSCH repetitions based at least in part on the transport block size.

In some aspects, a non-transitory computer-readable medium storing a set of instructions for wireless communication includes one or more instructions that, when executed by one or more processors of a base station, cause the base station to: transmit a PUSCH repetition configuration comprising an indication to determine a transport block size based at least in part on a set of PUSCH resources corresponding to a set of PUSCH repetitions that are configured to be transmitted over a repetition unit having a plurality of slots in accordance with a frequency hopping pattern that is configured such that a repetition slot count associated with the repetition unit and a frequency hop length are related by an integer-multiple relationship; and receive the set of PUSCH repetitions based at least in part on the transport block size.

In some aspects, an apparatus for wireless communication includes means for determining a transport block size based at least in part on a set of PUSCH resources corresponding to a set of PUSCH repetitions that are configured to be transmitted over a repetition unit having a plurality of slots in accordance with a frequency hopping pattern that is configured such that a repetition slot count associated with the repetition unit and a frequency hop length are related by an integer-multiple relationship; and means for transmitting the set of PUSCH repetitions based at least in part on the transport block size.

In some aspects, an apparatus for wireless communication includes means for transmitting a PUSCH repetition configuration comprising an indication to determine a transport block size based at least in part on a set of PUSCH resources corresponding to a set of PUSCH repetitions that are configured to be transmitted over a repetition unit having a plurality of slots in accordance with a frequency hopping pattern that is configured such that a repetition slot count associated with the repetition unit and a frequency hop length are related by an integer-multiple relationship; and means for receiving the set of PUSCH repetitions based at least in part on the transport block size.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with various aspects of the present disclosure.

FIG. 2 is a diagram illustrating an example of a base station in communication with a UE in a wireless network, in accordance with various aspects of the present disclosure.

FIG. 3 is a diagram illustrating an example of physical uplink shared channel (PUSCH) repetition, in accordance with various aspects of the present disclosure.

FIG. 4 is a diagram illustrating an example of PUSCH repetition with frequency hopping, in accordance with various aspects of the present disclosure.

FIGS. 5-8 are diagrams illustrating examples associated with PUSCH repetitions with transport block scaling and frequency hopping, in accordance with various aspects of the present disclosure.

FIGS. 9-10 are diagrams illustrating example processes associated with PUSCH repetitions with transport block scaling and frequency hopping, in accordance with various aspects of the present disclosure.

FIGS. 11-12 are block diagrams of example apparatuses for wireless communication, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

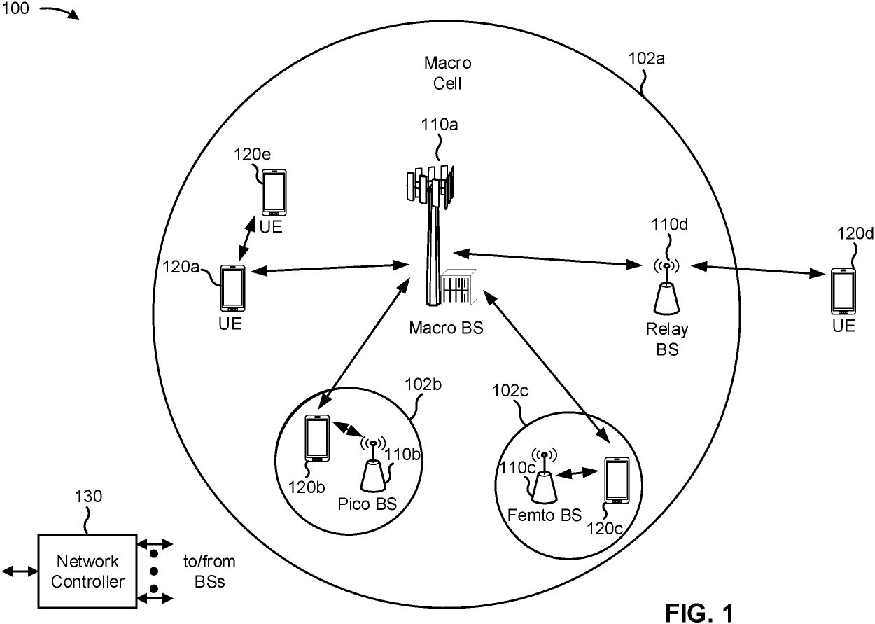

FIG. 1 is a diagram illustrating an example of a wireless network 100, in accordance with various aspects of the present disclosure. The wireless network 100 may be or may include elements of a 5G (NR) network, an LTE network, and/or the like. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components, memory components, and/or the like. In some aspects, the processor components and the memory components may be coupled together. For example, the processor components (e.g., one or more processors) and the memory components (e.g., a memory) may be operatively coupled, communicatively coupled, electronically coupled, electrically coupled, and/or the like.

In general, any number of wireless networks may be deployed in a given geographic area. Each wireless network may support a particular RAT and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, and/or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz - 300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

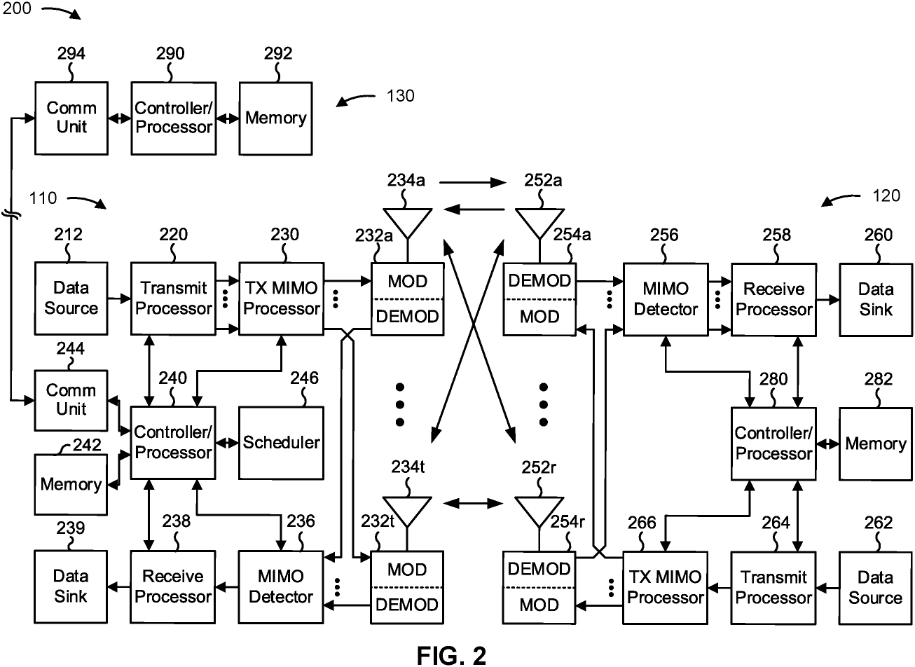

FIG. 2 is a diagram illustrating an example 200 of a base station 110 in communication with a UE 120 in a wireless network 100, in accordance with various aspects of the present disclosure. Base station 110 may be equipped with T antennas 234a through 234t, and UE 120 may be equipped with R antennas 252a through 252r, where in general T ≥ 1 and R ≥ 1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., a cell-specific reference signal (CRS), a demodulation reference signal (DMRS), and/or the like) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

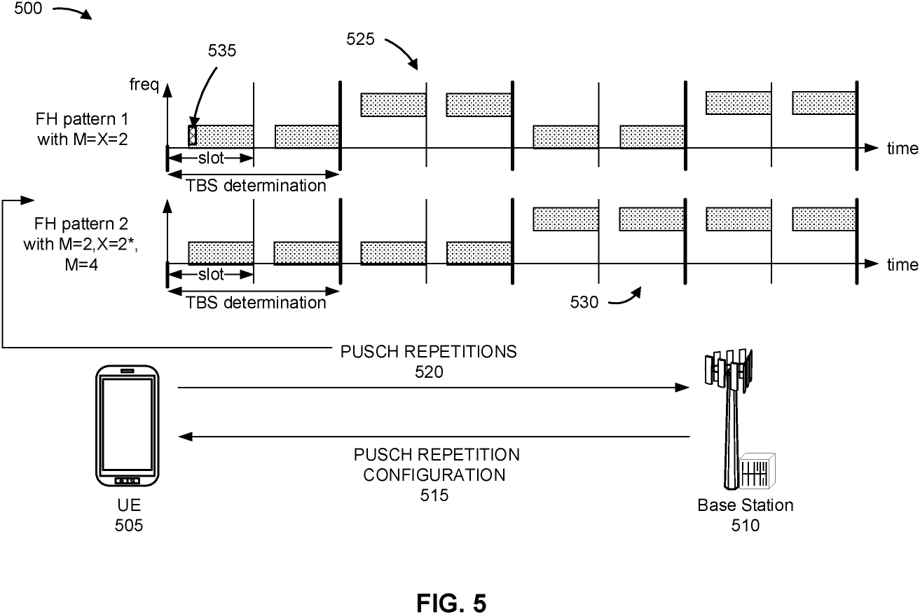

On the uplink, at UE 120, a transmit processor 264 may receive and process data from a data source 262 and control information (e.g., for reports that include RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein, for example, as described with reference to FIGS. 5-10.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein, for example, as described with reference to FIGS. 5-10.

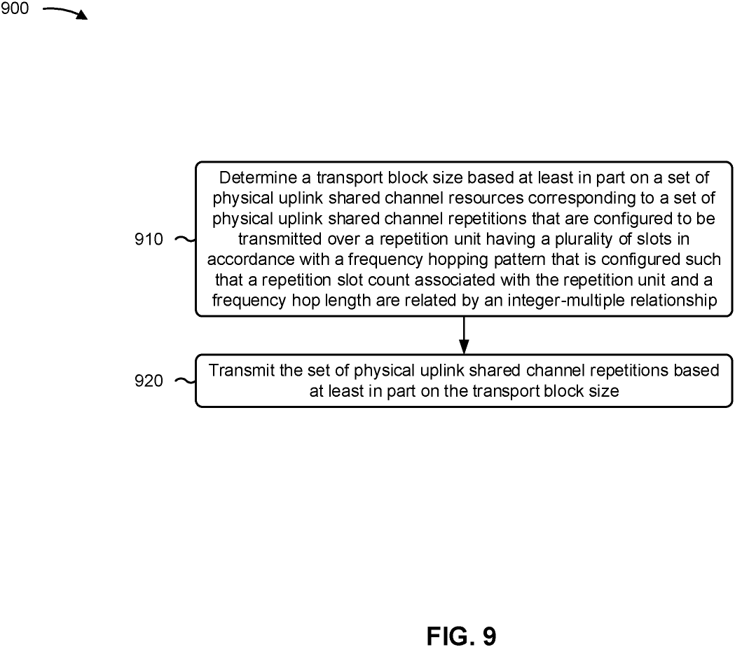

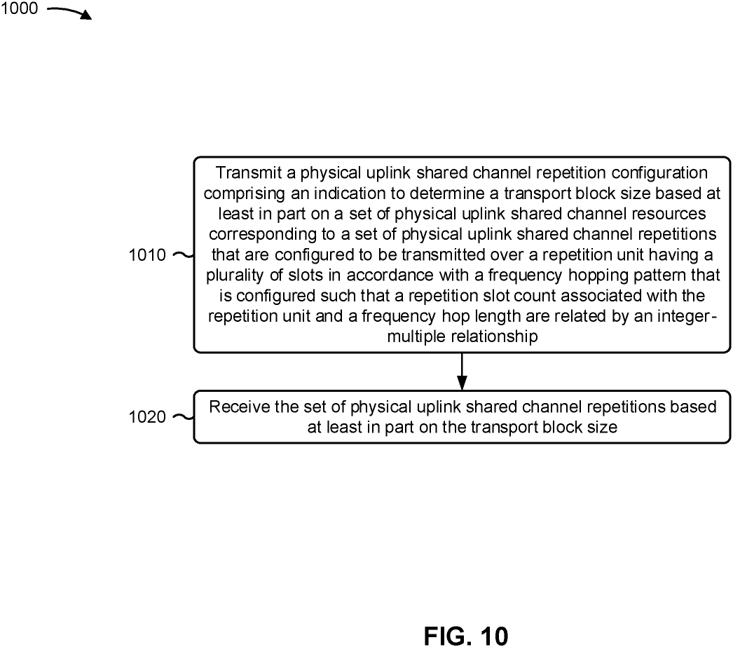

Controller/processor 240 of base station 110, controller/processor 280 of UE 120, and/or any other component(s) of FIG. 2 may perform one or more techniques associated with physical uplink shared channel (PUSCH) repetitions with transport block scaling and frequency hopping, as described in more detail elsewhere herein. For example, controller/processor 240 of base station 110, controller/processor 280 of UE 120, and/or any other component(s) of FIG. 2 may perform or direct operations of, for example, process 900 of FIG. 9, process 1000 of FIG. 10, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code, program code, and/or the like) for wireless communication. For example, the one or more instructions, when executed (e.g., directly, or after compiling, converting, interpreting, and/or the like) by one or more processors of the base station 110 and/or the UE 120, may cause the one or more processors, the UE 120, and/or the base station 110 to perform or direct operations of, for example, process 900 of FIG. 9, process 1000 of FIG. 10, and/or other processes as described herein. In some aspects, executing instructions may include running the instructions, converting the instructions, compiling the instructions, interpreting the instructions, and/or the like.

In some aspects, UE 120 may include means for determining a transport block size based at least in part on a set of physical uplink shared channel resources corresponding to a set of physical uplink shared channel repetitions that are configured to be transmitted over a repetition unit having a plurality of slots in accordance with a frequency hopping pattern that is configured such that a repetition slot count associated with the repetition unit and a frequency hop length are related by an integer-multiple relationship, means for transmitting the set of physical uplink shared channel repetitions based at least in part on the transport block size, and/or the like. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like.

In some aspects, base station 110 may include means for transmitting a physical uplink shared channel repetition configuration comprising an indication to determine a transport block size based at least in part on a set of physical uplink shared channel resources corresponding to a set of physical uplink shared channel repetitions that are configured to be transmitted over a repetition unit having a plurality of slots in accordance with a frequency hopping pattern that is configured such that a repetition slot count associated with the repetition unit and a frequency hop length are related by an integer-multiple relationship, means for receiving the set of physical uplink shared channel repetitions based at least in part on the transport block size, and/or the like. In some aspects, such means may include one or more components of base station 110 described in connection with FIG. 2, such as antenna 234, DEMOD 232, MIMO detector 236, receive processor 238, controller/processor 240, transmit processor 220, TX MIMO processor 230, MOD 232, antenna 234, and/or the like.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

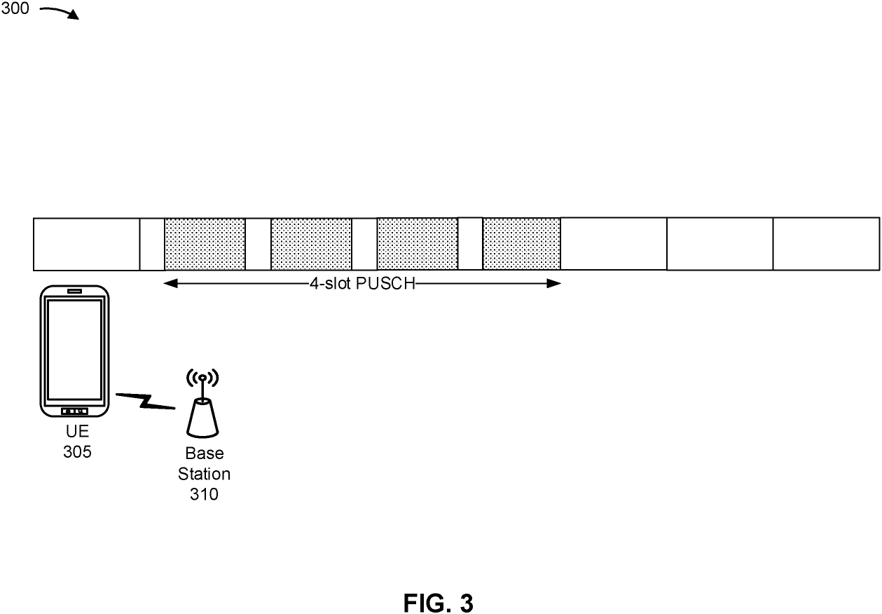

FIG. 3 is a diagram illustrating an example 300 of PUSCH repetition, in accordance with various aspects of the present disclosure. As shown in FIG. 3, a UE 305 and a base station 310 may communicate with one another. The UE 305 and the base station 310 may communicate with one another via a wireless network (e.g., the wireless network 100 shown in FIG. 1).

As shown, the UE 305 may repeat a transmission of a PUSCH communication over a number of slots. For example, as shown, the UE 305 may transmit a number of PUSCH repetitions over successive slots. As used herein, “repetition” refers to a communication that is transmitted more than one time, and refers to the initial transmission of that communication or any subsequent retransmission of that communication. PUSCH repetition (which may be referred to, for example, as slot-repetition, slot-aggregation, and/or multi-slot PUSCH) may be used to increase a signal-to-noise ratio (SNR) to improve transmission reliability.

A modulation and coding scheme (MCS) and/or a resource allocation may be indicated in a scheduling downlink control information (DCI) transmission. The MCS and/or the resource allocation may be common over the successive slots. For each slot of the multi-slot PUSCH, a transmission block may be the same (because the same data is being retransmitted. The encoded bits between PUSCH repetitions may differ.

For example, the redundancy version (RV) of each slot may be different. The RV of the first slot may be indicated in a scheduling DCI, while the RV of the n^{th} slot may be determined by ‘n mod 4.’ For example, for a first transmission of a 4-slot PUSCH, an RV order may be {RVO,RV2,RV3,RV1}. An RV order or a retransmission of a 4-slot PUSCH may be, for example, {RV3,RV1,RV0,RV2}.

As indicated above, FIG. 3 is provided as an example. Other examples may differ from what is described with regard to FIG. 3.

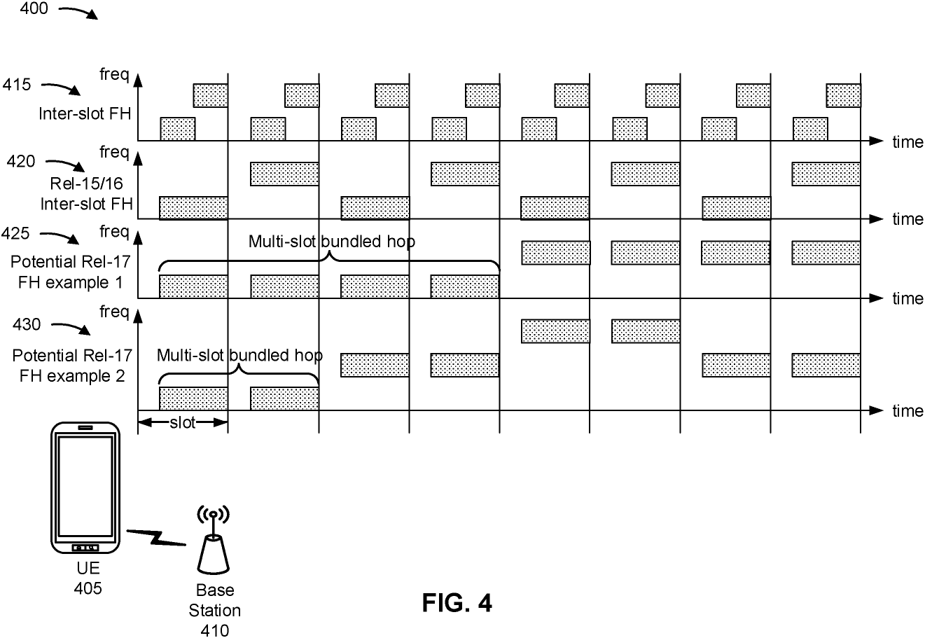

FIG. 4 is a diagram illustrating an example 400 of PUSCH repetition with frequency hopping, in accordance with various aspects of the present disclosure. As shown in FIG. 4, a UE 405 and a base station 410 may communicate with one another. The UE 405 and the base station 410 may communicate with one another via a wireless network (e.g., the wireless network 100 shown in FIG. 1). The UE 405 may be, or be similar to, the UE 305 shown in FIG. 3, and the base station 410 may be, or be similar to, the base station 310 shown in FIG. 3.

As shown, the UE 405 may transmit PUSCH communications using an intra-slot frequency hopping scheme 415 in which each frequency hop occurs within a slot, an inter-slot frequency hopping scheme 420 in which each frequency hop corresponds to a single slot, or an inter-slot frequency hopping scheme 425 in which each frequency hop corresponds to a multi-slot bundling (e.g., to enable channel estimation over the bundling). As shown, the frequency hopping scheme 415, 420, or 425 may include two frequency locations. In some cases, a frequency hopping scheme 430 may include more than two frequency locations to improve frequency resource diversity. The multi-slot hops may include demodulation reference signal (DMRS) patterns with reduced DMRS symbols. For example, cross-slot channel estimation may facilitate reducing the DMRS symbols.

Transport blocks transmitted in different transmission time intervals (TTIs) (e.g., slots, mini-slots, sets of symbols, and/or the like) may be associated with different parameters used to determine respective transport block sizes of those transport blocks. A parameter used to determine a size of a transport block may be referred to as a transport block size determination parameter, and may include, for example, an MCS used for the transport block, a number of resource elements allocated for the transport block, a number of layers to be used to transmit the transport block, and/or the like. When different transport blocks are transmitted in different TTIs and/or by different base stations 310, those transport blocks may have different transport block sizes if those transport blocks are associated with different transport block size determination parameters.

In a typical case, transport block size may be determined with PUSCH resources of a single slot, even in the case of PUSCH repetition. For example, transport block size may be determined in accordance with the relationship TBS + L_{CRC} ≈ N_{RE} • R • Qₘ, where R and Qₘ are code rate and modulation order indicated by MCS, respectively, and N_{RE} is the total number of data resource elements of PUSCH in a single slot. Determining transport block size in this way can result in a very low effective code rate for a multi-slot PUSCH since the effective code rate, R_{eff,multi-slot}=R/M, where M is the number of slots.

However, for uplink limited coverage scenarios, where the transmit power of the UE 305 is a bottleneck, further lowering of an already-low effective code rate, R_{eff}, can be harmful to the transmission reliability and can increase consumption of resources and/or bandwidth. For example, a double bandwidth associated with half of an effective coding rate (R_{eff}/2) lowers the power spectrum density (PSD) by 3 dB for uplink with limited transmit power. SNR also is decreased by 3 dB. Although the combining gain of R_{eff}/2 may generally be 3 dB, the channel estimation loss due to the lower SNR makes this gain less than 3 dB. Reducing the effective code rate in this way is thus not sufficient for compensating for the SNR loss, and may negatively impact network performance.

According to some aspects of the techniques and apparatuses described herein, transport block size may be determined based at least in part on PUSCH resources over multiple slots. For example, transport block size may be scaled using an integer factor, M, that corresponds to a repetition slot count. In some aspects, transport block size determination may be based at least in part on PUSCH resources corresponding to a set of PUSCH repetitions that are configured to be transmitted over a repetition unit. The repetition unit may include a plurality of slots in accordance with a frequency hopping pattern. The frequency hopping pattern may be configured such that a repetition slot count associated with the repetition unit, and a frequency hop length, are related by an integer-multiple relationship. In this way, a TB can distribute in a more balanced way among two or more frequency hops to improve coverage or transmission reliability.

As indicated above, FIG. 4 is provided as an example. Other examples may differ from what is described with regard to FIG. 4.

FIG. 5 is a diagram illustrating an example 500 associated with PUSCH repetitions with transport block scaling and frequency hopping, in accordance with various aspects of the present disclosure. As shown in FIG. 5, a UE 505 (e.g., similar to the UE 405 shown in FIG. 4) and a base station 410 (e.g., similar to the base station 410 shown in FIG. 4) may communicate with one another. The UE 505 and the base station 510 may communicate with one another via a wireless network (e.g., the wireless network 100 shown in FIG. 1). The UE 505 may be, or be similar to, the UE 120 shown in FIG. 1, and the base station 510 may be, or be similar to, the base station 110 shown in FIG. 1.

As shown by reference number 515, the base station 510 may transmit, and the UE 505 may receive, a PUSCH repetition configuration. In some aspects, the PUSCH repetition configuration may be carried in a radio resource control message. The PUSCH repetition configuration may include an indication to determine a transport block size based at least in part on a set of PUSCH resources. The PUSCH resources may correspond to a set of PUSCH repetitions that are configured to be transmitted over a repetition unit.

The repetition unit may include a plurality of slots in accordance with a frequency hopping pattern. The frequency hopping pattern may be configured such that a repetition slot count M associated with the repetition unit, and a frequency hop length X, are related by an integer-multiple relationship. In some aspects, the base station 510 may transmit, and the UE 505 may receive, a radio resource control configuration that includes an indication of the frequency hopping pattern. The indication of the frequency hopping pattern may indicate the frequency hop length X. In some aspects, the indication of the frequency hopping pattern does not indicate the frequency hop length X. In those cases, the UE 505 may determine that the frequency hop length X comprises a default frequency hop length X. The default frequency hop length X may be equal to the repetition slot count M.

As shown by reference number 520, the UE 505 may transmit, and the base station 510 may receive, the set of PUSCH repetitions. The UE 505 may transmit the set of PUSCH repetitions based at least in part on the transport block size, a frequency hopping pattern, and/or the PUSCH repetition configuration. As shown by reference number 525, for example, the frequency hopping pattern may include a first frequency hopping pattern (shown as “FH pattern 1”). The first frequency hopping pattern may include an inter-M-slot-unit frequency hopping pattern. The frequency hop length X may be equal to the repetition slot count M. As shown by reference number 530, the frequency hopping pattern may include a second frequency hopping pattern (shown as “FH pattern 2”). The second frequency hopping pattern may include an inter-M-slot-unit frequency hopping pattern with multiple M-slot units bundled. The frequency hop length X may be an integer multiple of the repetition slot count M.

In some aspects, the frequency hopping pattern may include an intra-repetition unit frequency hop or an inter-repetition unit frequency hop. For example, in some aspects, simultaneous configuration of intra-repetition unit frequency hopping and inter-repetition unit frequency hopping may not be supported. In some aspects, a total number of slots, N, associated with the set of PUSCH repetitions may be indicated by a dedicated parameter and may be greater than or equal to the repetition slot count M. For example, in some aspects, N may be indicated by a separate parameter than M or X, and N may be greater than or equal to M, which means it may be possible that the last hop can be shorter than other hops. For example, the frequency hopping scheme may include N mod X slots for the last hop, which may not necessarily be an integer multiple of M.

In some aspects, determining the total number of slots N may include multiplying a multiplier parameter, K, by the repetition slot count M. Thus, in some aspects, N=K×M. For example, for the second frequency hopping FH pattern 2, it may be possible that the last hop can have a smaller number of M-slot-units than other hops (e.g., (K mod X1)×M slots for the last hop). In some aspects, the UE 505 may determine the total number of slots N by multiplying a multiplier parameter K by the frequency hop length X. In some aspects, transport block size may be determined by the total number of data resources in an M-slot-unit (e.g., for different DMRS patterns of slots in an M-slot-unit, simply scaling-up may not be appropriate).

In some aspects, the second frequency hopping pattern may be radio resource control configured by the integer number of multiples (e.g., denoted as a parameter X1, where X=X1×M). For example, the default pattern of the second frequency hopping pattern (without further parameters/configurations) may be one M-slot-unit per hop (e.g., X1=1, which is the same as the first frequency hopping pattern).

In some aspects, the frequency hopping pattern may include an inter-repetition unit frequency hop, and as shown by reference number 535, a first DMRS corresponding to a first slot of the repetition unit may be different than a second DMRS pattern corresponding to a second slot of the repetition unit. For example, in some aspects, one of the first slot or the second slot of the repetition unit does not include a DMRS symbol.

As indicated above, FIG. 5 is provided as an example. Other examples may differ from what is described with regard to FIG. 5.

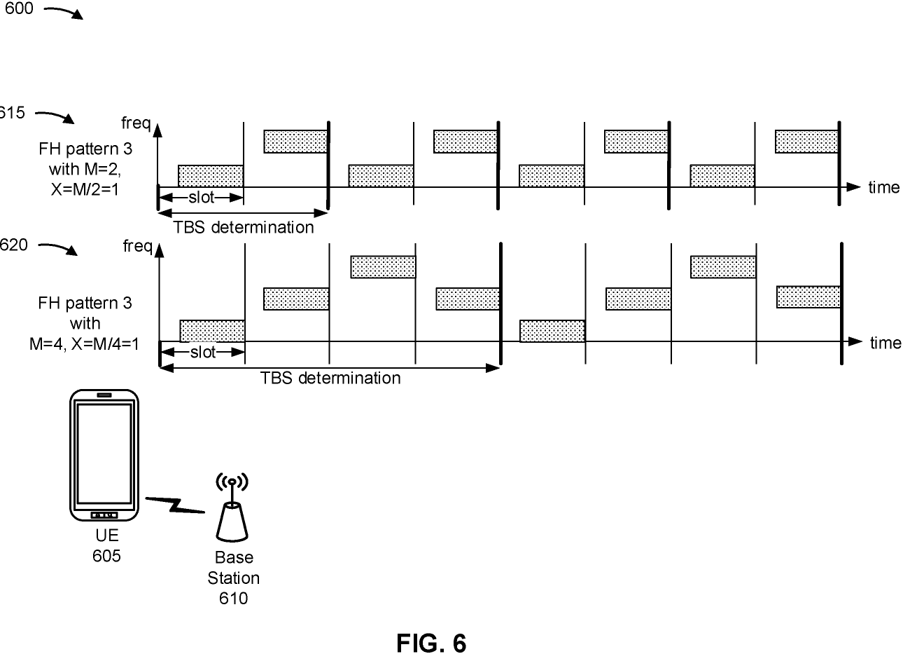

FIG. 6 is a diagram illustrating an example 600 associated with PUSCH repetitions with transport block scaling and frequency hopping, in accordance with various aspects of the present disclosure. As shown in FIG. 6, a UE 605 and a base station 610 may communicate with one another. The UE 605 and the base station 610 may communicate with one another via a wireless network (e.g., the wireless network 100 shown in FIG. 1). The UE 605 may be, or be similar to, the UE 505 shown in FIG. 5 and/or the UE 120 shown in FIG. 1. The base station 610 may be, or be similar to, the base station 510 shown in FIG. 5 and/or the base station 110 shown in FIG. 1.

As shown by reference number 615, the UE 605 may transmit PUSCH repetitions to the base station 610 in accordance with a third frequency hopping pattern (shown as FH pattern 3). In some aspects, the repetition slot count M may be an integer multiple of the frequency hop length X. For example, the frequency hopping pattern may include two frequency locations. The repetition slot count M may be two times the frequency hop length X. In some aspects, as shown by reference number 620, the frequency hopping pattern may include more than two frequency locations. The repetition slot count M may be equal to a quantity of frequency hops in a frequency hop periodicity associated with the frequency hopping pattern.

As indicated above, FIG. 6 is provided as an example. Other examples may differ from what is described with regard to FIG. 6.

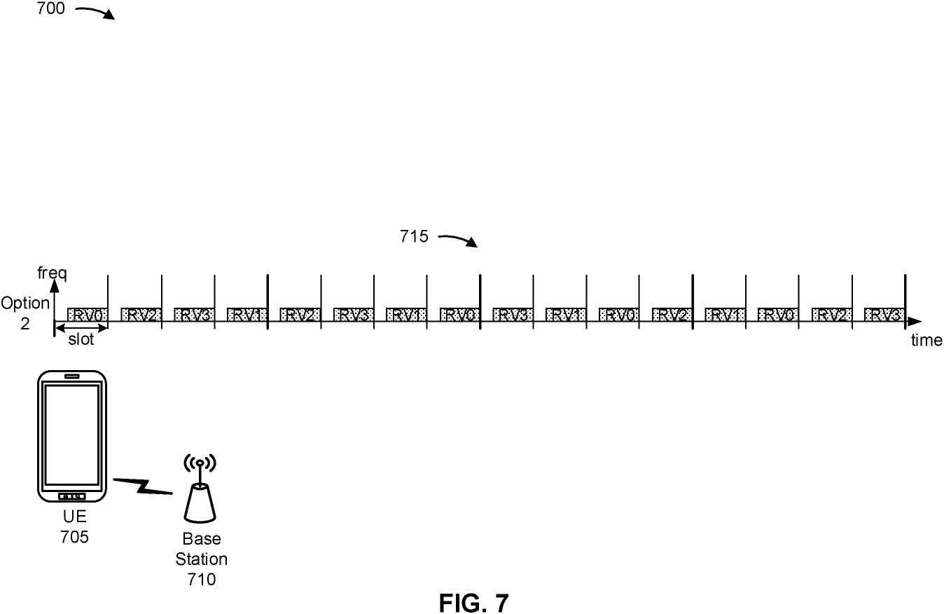

FIG. 7 is a diagram illustrating an example 700 associated with PUSCH repetitions with transport block scaling and frequency hopping, in accordance with various aspects of the present disclosure. As shown in FIG. 7, a UE 705 and a base station 710 may communicate with one another. The UE 705 and the base station 710 may communicate with one another via a wireless network (e.g., the wireless network 100 shown in FIG. 1). The UE 705 may be, or be similar to, the UE 605 shown in FIG. 6, the UE 505 shown in FIG. 5 and/or the UE 120 shown in FIG. 1. The base station 610 may be, or be similar to, the base station 610 shown in FIG. 6, the base station 510 shown in FIG. 5 and/or the base station 110 shown in FIG. 1.

As shown by reference number 715, the UE 705 may perform a two-level redundancy version cycle procedure. As shown, for example, the UE 705 may cycle a first slot of each repetition unit of a plurality of repetition units as an outer level. The plurality of repetition units may include the repetition. The UE 705 may cycle a plurality of slots within the repetition unit as an inner level.

As indicated above, FIG. 7 is provided as an example. Other examples may differ from what is described with regard to FIG. 7.

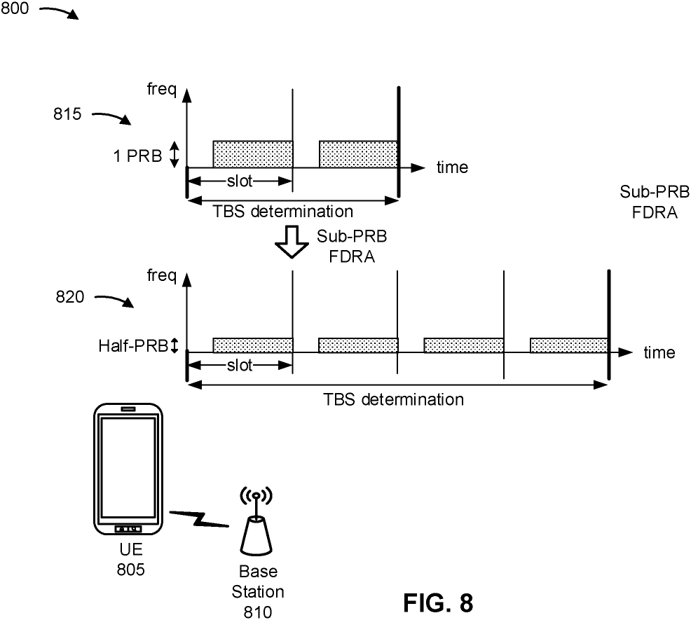

FIG. 8 is a diagram illustrating an example 800 associated with PUSCH repetitions with transport block scaling and frequency hopping, in accordance with various aspects of the present disclosure. As shown in FIG. 8, a UE 805 and a base station 810 may communicate with one another. The UE 805 and the base station 810 may communicate with one another via a wireless network (e.g., the wireless network 100 shown in FIG. 1). The UE 805 may be, or be similar to, the UE 705 shown in FIG. 7, the UE 605 shown in FIG. 6, the UE 505 shown in FIG. 5 and/or the UE 120 shown in FIG. 1. The base station 610 may be, or be similar to, the base station 710 shown in FIG. 7, the base station 610 shown in FIG. 6, the base station 510 shown in FIG. 5 and/or the base station 110 shown in FIG. 1.

As shown by reference number 815, a resource allocation may include a physical resource block (PRB). As shown by reference number 820, a resource allocation may be a smaller than a PRB resource allocation (e.g., denoted as “⅟P PRB” such as “112 PRB,” “⅓ PRB,” “¼ PRB,” “⅙ PRB”). In such situations, the base station 810 may modify one or more parameters associated with the set of PUSCH repetitions based at least in part on the resource allocation. The one or more parameters may include at least one of: the repetition slot count M (e.g., the number of slots for transmission block size determination), a total number of repetition slots, or the frequency hop length X.

As indicated above, FIG. 8 is provided as an example. Other examples may differ from what is described with regard to FIG. 8.

FIG. 9 is a diagram illustrating an example process 900 performed, for example, by a UE, in accordance with various aspects of the present disclosure. Example process 900 is an example where the UE (e.g., UE 120) performs operations associated with PUSCH repetitions with transport block scaling and frequency hopping.

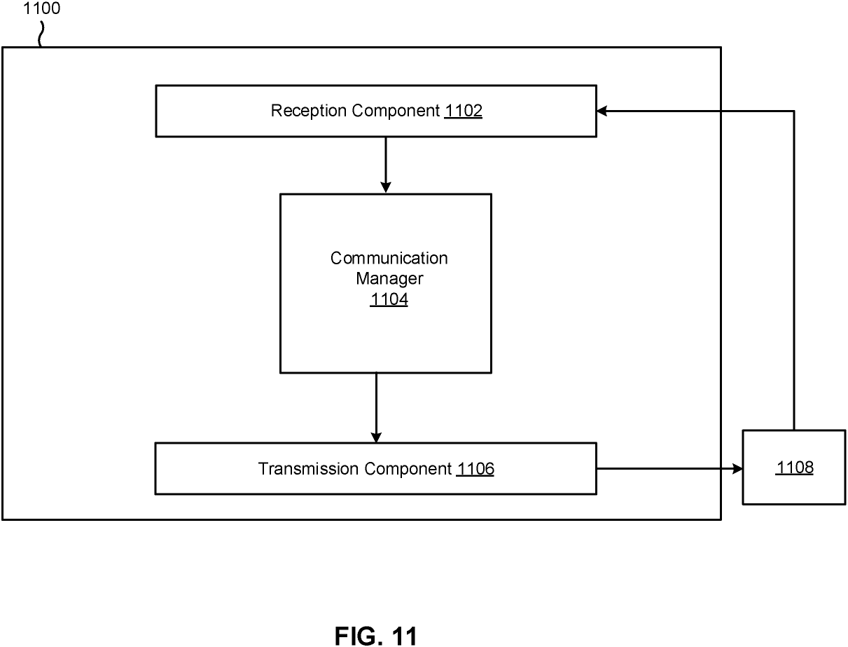

As shown in FIG. 9, in some aspects, process 900 may include determining a transport block size based at least in part on a set of PUSCH resources corresponding to a set of PUSCH repetitions that are configured to be transmitted over a repetition unit having a plurality of slots in accordance with a frequency hopping pattern that is configured such that a repetition slot count associated with the repetition unit and a frequency hop length are related by an integer-multiple relationship (block 910). For example, the UE (e.g., using communication manager 1104, depicted in FIG. 11) may determine a transport block size based at least in part on a set of PUSCH resources corresponding to a set of PUSCH repetitions that are configured to be transmitted over a repetition unit having a plurality of slots in accordance with a frequency hopping pattern that is configured such that a repetition slot count associated with the repetition unit and a frequency hop length are related by an integer-multiple relationship, as described above.

As further shown in FIG. 9, in some aspects, process 900 may include transmitting the set of PUSCH repetitions based at least in part on the transport block size (block 920). For example, the UE (e.g., using transmission component 1106, depicted in FIG. 11) may transmit the set of PUSCH repetitions based at least in part on the transport block size, as described above.

Process 900 may include additional aspects, such as any single aspect or any combination of aspects described below and/or in connection with one or more other processes described elsewhere herein.

With respect to process 900, in some aspects, the frequency hop length is equal to the repetition slot count.

With respect to process 900, in some aspects, the frequency hop length is an integer multiple of the repetition slot count.

In some aspects, process 900 includes receiving a radio resource control configuration comprising an indication of the frequency hopping pattern.

With respect to process 900, in some aspects, the indication of the frequency hopping pattern indicates the frequency hop length.

With respect to process 900, in some aspects, the indication of the frequency hopping pattern does not indicate the frequency hop length, and process 900 further comprises determining that the frequency hop length comprises a default frequency hope length, wherein the default frequency hop length is equal to the repetition slot count.

With respect to process 900, in some aspects, the repetition slot count is an integer multiple of the frequency hop length.

With respect to process 900, in some aspects, the frequency hopping pattern comprises two frequency locations, and the repetition slot count is two times the frequency hop length.

With respect to process 900, in some aspects, the frequency hopping pattern comprises more than two frequency locations, and the repetition slot count is equal to a quantity of frequency hops in a frequency hop periodicity associated with the frequency hopping pattern.

With respect to process 900, in some aspects, the frequency hopping pattern comprises an intra-repetition unit frequency hop or an inter-repetition unit frequency hop.

With respect to process 900, in some aspects, the frequency hopping pattern comprises an inter-repetition unit frequency hop, and a first demodulation reference signal pattern corresponding to a first slot of the repetition unit is different than a second demodulation reference signal pattern corresponding to a second slot of the repetition unit.

With respect to process 900, in some aspects, one of the first slot and the second slot of the repetition unit does not include a demodulation reference signal symbol.

With respect to process 900, in some aspects, a total number of slots associated with the set of PUSCH repetitions is indicated by a dedicated parameter and is greater than or equal to the repetition slot count.

In some aspects, process 900 includes determining the total number of slots by multiplying a multiplier parameter by the repetition slot count.

In some aspects, process 900 includes determining the total number of slots by multiplying a multiplier parameter by the frequency hop length.

With respect to process 900, in some aspects, transmitting the set of PUSCH repetitions comprises performing a two-level redundancy version cycle procedure.

With respect to process 900, in some aspects, performing the two-level redundancy version cycle procedure comprises cycling a first slot of each repetition unit of a plurality of repetition units as an outer level, wherein the plurality of repetition units include the repetition unit, and cycling a plurality of slots within the repetition unit as an inner level.

In some aspects, process 900 includes receiving a resource allocation that indicates a frequency domain resource that is smaller than a physical resource block.

In some aspects, process 900 includes modifying one or more parameters associated with the set of PUSCH repetitions based at least in part on the resource allocation, the one or more parameters comprising at least one of the repetition slot count, a total number of repetition slots, or the frequency hop length.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a base station, in accordance with various aspects of the present disclosure. Example process 1000 is an example where the base station (e.g., base station 110) performs operations associated with PUSCH repetitions with transport block scaling and frequency hopping.

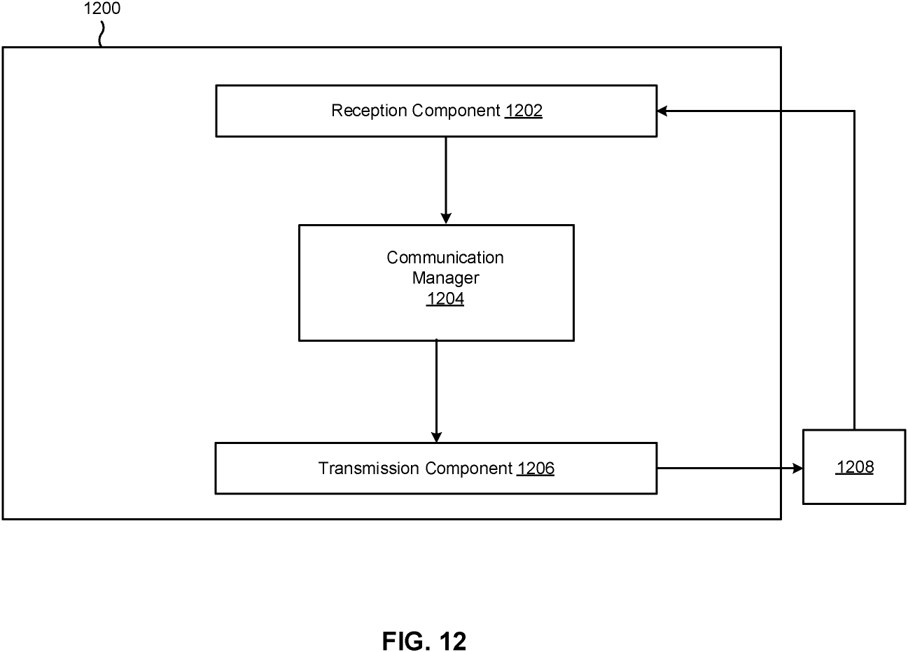

As shown in FIG. 10, in some aspects, process 1000 may include transmitting a PUSCH repetition configuration comprising an indication to determine a transport block size based at least in part on a set of PUSCH resources corresponding to a set of PUSCH repetitions that are configured to be transmitted over a repetition unit having a plurality of slots in accordance with a frequency hopping pattern that is configured such that a repetition slot count associated with the repetition unit and a frequency hop length are related by an integer-multiple relationship (block 1010). For example, the base station (e.g., using transmission component 1206, depicted in FIG. 12) may transmit a PUSCH repetition configuration comprising an indication to determine a transport block size based at least in part on a set of PUSCH resources corresponding to a set of PUSCH repetitions that are configured to be transmitted over a repetition unit having a plurality of slots in accordance with a frequency hopping pattern that is configured such that a repetition slot count associated with the repetition unit and a frequency hop length are related by an integer-multiple relationship, as described above.

As further shown in FIG. 10, in some aspects, process 1000 may include receiving the set of PUSCH repetitions based at least in part on the transport block size (block 1020). For example, the base station (e.g., using reception component 1202, depicted in FIG. 12) may receive the set of PUSCH repetitions based at least in part on the transport block size, as described above.

Process 1000 may include additional aspects, such as any single aspect or any combination of aspects described below and/or in connection with one or more other processes described elsewhere herein.

With respect to process 1000, in some aspects, the frequency hop length is equal to the repetition slot count.

With respect to process 1000, in some aspects, the frequency hop length is an integer multiple of the repetition slot count.

In some aspects, process 1000 includes transmitting a radio resource control configuration comprising an indication of the frequency hopping pattern, wherein the indication of the frequency hopping pattern indicates the frequency hop length.

With respect to process 1000, in some aspects, the indication of the frequency hopping pattern indicates the frequency hop length.

With respect to process 1000, in some aspects, the indication of the frequency hopping pattern does not indicate the frequency hop length, and the frequency hop length comprises a default frequency hope length, wherein the default frequency hop length is equal to the repetition slot count.

With respect to process 1000, in some aspects, the repetition slot count is an integer multiple of the frequency hop length.

With respect to process 1000, in some aspects, the frequency hopping pattern comprises two frequency locations, and the repetition slot count is two times the frequency hop length.

With respect to process 1000, in some aspects, the frequency hopping pattern comprises more than two frequency locations, and the repetition slot count is equal to a quantity of frequency hops in a frequency hop periodicity associated with the frequency hopping pattern.

With respect to process 1000, in some aspects, the frequency hopping pattern comprises an intra-repetition unit frequency hop or an inter-repetition unit frequency hop.

With respect to process 1000, in some aspects, the frequency hopping pattern comprises an inter-repetition unit frequency hop, and a first demodulation reference signal pattern corresponding to a first slot of the repetition unit is different than a second demodulation reference signal pattern corresponding to a second slot of the repetition unit.

With respect to process 1000, in some aspects, one of the first slot and the second slot of the repetition unit does not include a demodulation reference signal symbol.

With respect to process 1000, in some aspects, a total number of slots associated with the set of PUSCH repetitions is indicated by a dedicated parameter and is greater than or equal to the repetition slot count.

With respect to process 1000, in some aspects, the total number of slots is determined by multiplication of a multiplier parameter by the repetition slot count.

With respect to process 1000, in some aspects, the total number of slots is determined by multiplication of a multiplier parameter by the frequency hop length.

With respect to process 1000, in some aspects, transmitting the set of PUSCH repetitions comprises performing a two-level redundancy version cycle procedure.

With respect to process 1000, in some aspects, the two-level redundancy version cycle procedure comprises a first cycle of a first slot of each repetition unit of a plurality of repetition units as an outer level, wherein the plurality of repetition units include the repetition unit, and a second cycle of a plurality of slots within the repetition unit as an inner level.

In some aspects, process 1000 includes transmitting a resource allocation that indicates a frequency domain resource that is smaller than a physical resource block.

With respect to process 1000, in some aspects, one or more parameters associated with the set of PUSCH repetitions is modified based at least in part on the resource allocation, the one or more parameters comprising at least one of the repetition slot count, a total number of repetition slots, or the frequency hop length.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a block diagram of an example apparatus 1100 for wireless communication in accordance with various aspects of the present disclosure. The apparatus 1100 may be, be similar to, include, or be included in a UE (e.g., UE 505 shown in FIG. 5). In some aspects, the apparatus 1100 includes a reception component 1102, a communication manager 1104, and a transmission component 1106, which may be in communication with one another (for example, via one or more buses). As shown, the apparatus 1100 may communicate with another apparatus 1108 (such as a client, a server, a UE, a base station, or another wireless communication device) using the reception component 1102 and the transmission component 1106.

In some aspects, the apparatus 1100 may be configured to perform one or more operations described herein in connection with FIGS. 5-8. Additionally, or alternatively, the apparatus 1100 may be configured to perform one or more processes described herein, such as process 900 of FIG. 9. In some aspects, the apparatus 1100 may include one or more components of the first UE described above in connection with FIG. 2.

The reception component 1102 may provide means for receiving communications, such as reference signals, control information, data communications, or a combination thereof, from the apparatus 1108. The reception component 1102 may provide received communications to one or more other components of the apparatus 1100, such as the communication manager 1104. In some aspects, the reception component 1102 may provide means for signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1102 may include one or more antennas, a demodulator, a MIMO detector, a receive processor, a controller/processor, a memory, or a combination thereof, of the first UE described above in connection with FIG. 2.

The transmission component 1106 may provide means for transmitting communications, such as reference signals, control information, data communications, or a combination thereof, to the apparatus 1108. In some aspects, the communication manager 1104 may generate communications and may transmit the generated communications to the transmission component 1106 for transmission to the apparatus 1108. In some aspects, the transmission component 1106 may provide means for performing signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1106 may include one or more antennas, a modulator, a transmit MIMO processor, a transmit processor, a controller/processor, a memory, or a combination thereof, of the first UE described above in connection with FIG. 2. In some aspects, the transmission component 1106 may be co-located with the reception component 1102 in a transceiver.

In some aspects, the communication manager 1104 may provide means for determining a transport block size based at least in part on a set of PUSCH resources corresponding to a set of PUSCH repetitions that are configured to be transmitted over a repetition unit having a plurality of slots in accordance with a frequency hopping pattern that is configured such that a repetition slot count associated with the repetition unit and a frequency hop length are related by an integer-multiple relationship; and transmitting the set of PUSCH repetitions based at least in part on the transport block size. In some aspects, the communication manager 1104 may include a controller/processor, a memory, or a combination thereof, of the first UE described above in connection with FIG. 2. In some aspects, the communication manager 1104 may include the reception component 1102, the transmission component 1106, and/or the like. In some aspects, the means provided by the communication manager 1104 may include, or be included within, means provided by the reception component 1102, the transmission component 1106, and/or the like.

In some aspects, the communication manager 1104 and/or one or more components of the communication manager 1104 may include or may be implemented within hardware (e.g., circuitry described in connection with FIG. 2). In some aspects, the communication manager 1104 and/or one or more components thereof may include or may be implemented within a controller/processor, a memory, or a combination thereof, of the UE 120 described above in connection with FIG. 2.

In some aspects, the communication manager 1104 and/or one or more components of the communication manager 1104 may be implemented in code (e.g., as software or firmware stored in a memory). For example, the communication manager 1104 and/or a component (or a portion of a component) of the communication manager 1104 may be implemented as instructions or code stored in a non-transitory computer-readable medium and executable by a controller or a processor to perform the functions or operations of the communication manager 1104 and/or the component. If implemented in code, the functions of the communication manager 1104 and/or a component may be executed by a controller/processor, a memory, a scheduler, a communication unit, or a combination thereof, of the UE 120 described above in connection with FIG. 2.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a block diagram of an example apparatus 1200 for wireless communication in accordance with various aspects of the present disclosure. The apparatus 1200 may be, be similar to, include, or be included in a base station (e.g., base station 510 shown in FIG. 5). In some aspects, the apparatus 1200 includes a reception component 1202, a communication manager 1204, and a transmission component 1206, which may be in communication with one another (for example, via one or more buses). As shown, the apparatus 1200 may communicate with another apparatus 1208 (such as a client, a server, a UE, a base station, or another wireless communication device) using the reception component 1202 and the transmission component 1206.

In some aspects, the apparatus 1200 may be configured to perform one or more operations described herein in connection with FIGS. 5-8. Additionally, or alternatively, the apparatus 1000 may be configured to perform one or more processes described herein, such as process 1000 of FIG. 10. In some aspects, the apparatus 1200 may include one or more components of the base station described above in connection with FIG. 2.

The reception component 1202 may provide means for receiving communications, such as reference signals, control information, data communications, or a combination thereof, from the apparatus 1208. The reception component 1202 may provide received communications to one or more other components of the apparatus 1200, such as the communication manager 1204. In some aspects, the reception component 1202 may provide means for performing signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1202 may include one or more antennas, a demodulator, a MIMO detector, a receive processor, a controller/processor, a memory, or a combination thereof, of the base station described above in connection with FIG. 2.

The transmission component 1206 may provide means for transmitting communications, such as reference signals, control information, data communications, or a combination thereof, to the apparatus 1208. In some aspects, the communication manager 1204 may generate communications and may transmit the generated communications to the transmission component 1206 for transmission to the apparatus 1208. In some aspects, the transmission component 1206 may provide means for performing signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1206 may include one or more antennas, a modulator, a transmit MIMO processor, a transmit processor, a controller/processor, a memory, or a combination thereof, of the base station described above in connection with FIG. 2. In some aspects, the transmission component 1206 may be co-located with the reception component 1202 in a transceiver.

The communication manager 1204 may provide means for transmitting a PUSCH repetition configuration comprising an indication to determine a transport block size based at least in part on a set of PUSCH resources corresponding to a set of PUSCH repetitions that are configured to be transmitted over a repetition unit having a plurality of slots in accordance with a frequency hopping pattern that is configured such that a repetition slot count associated with the repetition unit and a frequency hop length are related by an integer-multiple relationship; and receiving the set of PUSCH repetitions based at least in part on the transport block size. In some aspects, the communication manager 1204 may include a controller/processor, a memory, a scheduler, a communication unit, or a combination thereof, of the base station described above in connection with FIG. 2. In some aspects, the communication manager 1204 may include the reception component 1202, the transmission component 1206, and/or the like. In some aspects, the means provided by the communication manager 1204 may include, or be included within means provided by the reception component 1202, the transmission component 1206, and/or the like.

In some aspects, the communication manager 1204 and/or one or more components thereof may include or may be implemented within hardware. In some aspects, the communication manager 1204 and/or one or more components thereof may include or may be implemented within a controller/processor, a memory, or a combination thereof, of the BS 110 described above in connection with FIG. 2.

In some aspects, the communication manager 1204 and/or one or more components thereof may be implemented in code (e.g., as software or firmware stored in a memory). For example, the communication manager 1204 and/or a component (or a portion of a component) of the communication manager 1204 may be implemented as instructions or code stored in a non-transitory computer-readable medium and executable by a controller or a processor to perform the functions or operations of the communication manager 1204 and/or the component. If implemented in code, the functions of the communication manager 1204 and/or a component may be executed by a controller/processor, a memory, a scheduler, a communication unit, or a combination thereof, of the BS 110 described above in connection with FIG. 2.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code-it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment for wireless communication, comprising:
a memory; and
one or more processors coupled to the memory, the memory and the one or more processors configured to:
determine a transport block size based at least in part on a set of physical uplink shared channel resources corresponding to a set of physical uplink shared channel repetitions that are configured to be transmitted over a repetition unit having a plurality of slots in accordance with a frequency hopping pattern that is configured such that a repetition slot count associated with the repetition unit and a frequency hop length are related by an integer-multiple relationship; and
transmit the set of physical uplink shared channel repetitions based at least in part on the transport block size.

2. The user equipment of claim 1, wherein the frequency hop length is equal to the repetition slot count.

3. The user equipment of claim 1, wherein the frequency hop length is an integer multiple of the repetition slot count.

4. The user equipment of claim 3, wherein the one or more processors are further configured to receive a radio resource control configuration comprising an indication of the frequency hopping pattern.

5. The user equipment of claim 4, wherein the indication of the frequency hopping pattern indicates the frequency hop length.

6. The user equipment of claim 4, wherein the indication of the frequency hopping pattern does not indicate the frequency hop length, and wherein the one or more processors are further configured to determine that the frequency hop length comprises a default frequency hope length, wherein the default frequency hop length is equal to the repetition slot count.

7. The user equipment of claim 1, wherein the repetition slot count is an integer multiple of the frequency hop length.

8. The user equipment of claim 7, wherein the frequency hopping pattern comprises two frequency locations, and wherein the repetition slot count is two times the frequency hop length.

9. The user equipment of claim 7, wherein the frequency hopping pattern comprises more than two frequency locations, and wherein the repetition slot count is equal to a quantity of frequency hops in a frequency hop periodicity associated with the frequency hopping pattern.

10. The user equipment of claim 1, wherein the frequency hopping pattern comprises an intra-repetition unit frequency hop or an inter-repetition unit frequency hop.

11. The user equipment of claim 1, wherein the frequency hopping pattern comprises an inter-repetition unit frequency hop, and wherein a first demodulation reference signal pattern corresponding to a first slot of the repetition unit is different than a second demodulation reference signal pattern corresponding to a second slot of the repetition unit.

12. The user equipment of claim 11, wherein one of the first slot and the second slot of the repetition unit does not include a demodulation reference signal symbol.

13. The user equipment of claim 1, wherein a total number of slots associated with the set of physical uplink shared channel repetitions is indicated by a dedicated parameter and is greater than or equal to the repetition slot count.

14. The user equipment of claim 13, wherein the one or more processors are further configured to determine the total number of slots by multiplying a multiplier parameter by the repetition slot count.

15. The user equipment of claim 13, wherein the one or more processors are further configured to determine the total number of slots by multiplying a multiplier parameter by the frequency hop length.

16. The user equipment of claim 1, wherein the one or more processors, when transmitting the set of physical uplink shared channel repetitions, are configured to perform a two-level redundancy version cycle procedure.

17. The user equipment of claim 16, wherein the one or more processors, when performing the two-level redundancy version cycle procedure, are configured to:
cycle a first slot of each repetition unit of a plurality of repetition units as an outer level, wherein the plurality of repetition units include the repetition unit; and
cycle a plurality of slots within the repetition unit as an inner level.

18. The user equipment of claim 1, wherein the one or more processors are further configured to receive a resource allocation that indicates a frequency domain resource that is smaller than a physical resource block.

19. The user equipment of claim 18, wherein the one or more processors are further configured to modify one or more parameters associated with the set of physical uplink shared channel repetitions based at least in part on the resource allocation, the one or more parameters comprising at least one of:
the repetition slot count,
a total number of repetition slots, or
the frequency hop length.

20. A base station for wireless communication, comprising:
a memory; and
one or more processors coupled to the memory, the memory and the one or more processors configured to:
transmit a physical uplink shared channel repetition configuration comprising an indication to determine a transport block size based at least in part on a set of physical uplink shared channel resources corresponding to a set of physical uplink shared channel repetitions that are configured to be transmitted over a repetition unit having a plurality of slots in accordance with a frequency hopping pattern that is configured such that a repetition slot count associated with the repetition unit and a frequency hop length are related by an integer-multiple relationship; and
receive the set of physical uplink shared channel repetitions based at least in part on the transport block size.

21. The base station of claim 20, wherein the frequency hop length is equal to the repetition slot count.

22. The base station of claim 20, wherein the frequency hop length is an integer multiple of the repetition slot count.

23. The base station of claim 22, wherein the one or more processors are further configured to transmit a radio resource control configuration comprising an indication of the frequency hopping pattern, wherein the indication of the frequency hopping pattern indicates the frequency hop length.

24. The base station of claim 23, wherein the indication of the frequency hopping pattern indicates the frequency hop length.

25. The base station of claim 23, wherein the indication of the frequency hopping pattern does not indicate the frequency hop length, and wherein the frequency hop length comprises a default frequency hope length, wherein the default frequency hop length is equal to the repetition slot count.

26. The base station of claim 20, wherein the repetition slot count is an integer multiple of the frequency hop length.

27. The base station of claim 26, wherein the frequency hopping pattern comprises two frequency locations, and wherein the repetition slot count is two times the frequency hop length.

28. The base station of claim 27, wherein the frequency hopping pattern comprises more than two frequency locations, and wherein the repetition slot count is equal to a quantity of frequency hops in a frequency hop periodicity associated with the frequency hopping pattern.

29. The base station of claim 20, wherein the frequency hopping pattern comprises an intra-repetition unit frequency hop or an inter-repetition unit frequency hop.

30. The base station of claim 20, wherein the frequency hopping pattern comprises an inter-repetition unit frequency hop, and wherein a first demodulation reference signal pattern corresponding to a first slot of the repetition unit is different than a second demodulation reference signal pattern corresponding to a second slot of the repetition unit.

31-80. (canceled)
